(19) United States
(12) Patent Application Publication
(10) Pub. No.: US 2006/0200273 A1
(43) Pub. Date: Sep. 7, 2006

(54) Method and apparatus for controling the advance movement of a joining tool

(75) Inventor: Hans Jorg Lang, Staudach (DE)

Correspondence Address: SEYFARTH SHAW LLP, 55 E. MONROE STREET, SUITE 4200, CHICAGO, IL, 60603-5803, US

(73) Assignee: Bollhoff Verbindungstechnik GmbH

(21) Appl. No.: 11/362,287

(22) Filed: Feb. 24, 2006

(30) Foreign Application Priority Data
Mar. 2, 2005 (DE) 10 2005 009 526.7

(51) Int. Cl. G06F 19/00

(52) U.S. Cl. 700/245

(57) ABSTRACT

In a method and an apparatus for controlling the advance movement of a joining tool, the joining tool fixed to the robot is moved from an initial position to a pre-position wherein the die of the joining tool is spaced from the workpieces to be joined for a certain distance. This distance is detected by a distance detecting means in order to generate a corresponding distance signal. The joining tool is moved by the positioning means of the robot in response to the distance signal precisely to the operating position wherein the die is in engagement with the workpiece. This allows to compensate for tolerances of the position of the stationary workpiece.

### BACKGROUND OF THE INVENTION

The present invention relates to a method and an apparatus for controlling the advance movement of a joining tool fixed to a robot, in particular a self-piercing riveting or clinching tool.

Such joining tools are used e.g. in the automotive industry to join car body sheets. It is inevitable that the workpieces to be joined (car body sheets) in the assembly line are subject to position tolerances (for example in the order of +/−2 mm). Therefore, it is difficult for the positioning means of the robot to move the joining tool precisely to the operating position wherein the die of the joining tool is in engagement with the workpieces to be joined.

In order to allow for gentle engagement between the die of the joining tool and the workpieces to be joined, it has become known for example to provide a relatively sophisticated compensation slide between the joining tool and the workpieces to perform compensation movements axially of the joining tool for compensating position tolerances of the workpieces. Such a compensation slide is relatively complicated, not easy to handle and expensive. Nevertheless, such a compensation slide is not always successful in providing gentle engagement between the die of the joining tool and the workpieces to be joined.

### SUMMARY OF THE INVENTION

It is a primary object of the present invention to provide a method and an apparatus for controlling an advance movement of a joining tool fixed to a robot from an initial position to an operating position, which allow for gentle engagement between the die of the joining tool and the workpieces to be joined in a simple and economical manner.

In accordance with the present invention, the joining tool fixed to the robot is moved, with the assistance of the positioning means of the robot, from an initial position to a pre-position wherein the die of the joining tool is spaced from the workpiece for a distance such that there will be no interference between the joining tool and the workpieces. The distance between the die and the workpieces to be fixed is then detected by a distance detecting means to generate a corresponding distance signal. This allows the positioning means of the robot to move the joining tool to the operating position, i.e. into engagement with the workpieces in a gentle and shock-free manner.

As a result position tolerances of the workpieces to be joined are compensated for without any complicated compensation devices such as compensation slides or the like. Since the present invention allows to compensate for relatively large position tolerances of the workpieces, very precise positioning of the workpieces is not necessary; this allows to simplify the clamping devices for retaining the workpieces.

The distance detecting means is in particular a position measuring device which is preferably of the mechanical or opto-electronic type, even though it may be a position measuring device of the resistance, capacitance or induction type. Movement of the joining tool from the pre-position to the operating position may be controlled by open or closed loop control.

Joining tools such as self-piercing riveting and clinching tools fixed to robots are generally provided with a C-shaped frame the upper leg of which carries an actuating mechanism including an operating punch and the lower leg of which carries a die. In a preferred embodiment of the invention, the lower leg of the C-shaped frame includes fixing means for fixing the joining tool to the robot, which fixing means are arranged on the lower leg such that it can be fixed to the robot closely adjacent to the die. As a result the position of the die relative to the workpieces during the joining operating is not or not substantially changed when the C-shaped frame is deflected by the joining forces so that the upper and lower legs of the C-shaped frames are urged apart.

### BRIEF DESCRIPTION OF THE DRAWINGS

For the purpose of facilitating an understanding the subject matter sought to be protected, there is illustrated in the accompanying drawings an embodiment thereof, from an inspection of which, when considered in connection with the following description, the subject matter sought to be protected, its construction and operation and many of its advantages should be readily understood and appreciated.

FIG. 1 is a schematical view of a joining tool comprising a self-piercing riveting tool adapted to be fixed to a robot;

FIGS. 2, 3 are views of details of the joining tool in FIG. 1 in different operating conditions;

FIGS. 4, 5 are views similar to FIGS. 2, 3 of a modified embodiment;

FIG. 6 is a view, similar to FIG. 1, of the joining tool during a joining operation.

### DETAILED DESCRIPTION OF THE DRAWINGS

With reference to FIG. 1, the self-piercing riveting tool 2 shown therein comprises, as usual, a C-shaped frame 4 with an intermediate portion 6, an upper arm 8, and a lower arm 10. The upper arm 8 carries an actuating mechanism 12 including a linearly displaceable operating punch 14. The lower arm 10 carries a die which is disposed along the same axis as the operating punch 14.

Since the structure and operation of such joining tools is well-known, no further explanations in this respect are necessary.

The joining tool 2 comprises fixing means 18 for being fixed to a robot (not shown). The structure of the fixing means 18 will be explained in more detail below, in particular with reference to FIG. 6.

The joining tool 2 is arranged to join at least one workpiece and in particular two or more workpieces W by self-piercing rivets (not shown). The workpieces W are held stationary by a clamping device (not shown). The workpieces W may be for example car body sheets of a vehicle which are to be joined in an assembly line.

When the workpieces W are being fixed, their positions may vary within certain position tolerances (for example +/−2 mm). For this reason the joining tool 2 is provided with an apparatus for controlling the advance movement of the joining tool fixed to the robot from an initial position to an operating position wherein the joining tool 2 may perform the joining operation on the workpieces W, i.e. wherein the workpieces W are in engagement with the die 16. This apparatus comprises a distance detecting means 28 mounted to the C-shaped frame 4 such that it may be able to detect a distance a between the die 16 and the workpieces W in order to provide a distance signal dependent on the distance a. This distance signal can be used by the positioning means of the robot (not shown) to control the advance movement of the joining tool 2 as will be explained in more detail now.

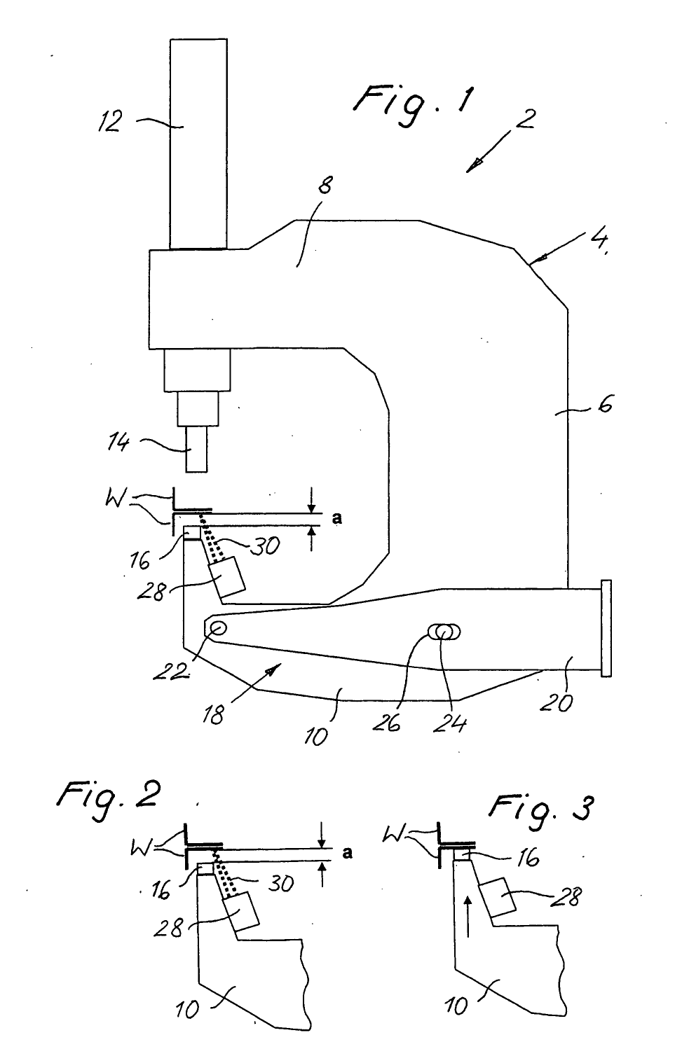

In the method for controlling the advance movement of the joining tool, initially the joining tool 2 fixed to the robot is moved with the assistance of the positioning means (not shown) of the robot from the initial position to a pre-position wherein the joining tool 2 is spaced from the workpieces W by a distance a; the distance a is selected such that there will be no collision between the joining tool 4 and the workpieces W in spite of the position tolerances of the workpieces W (FIGS. 1 and 2).

When the joining tool 2 has reached the pre-position, the distance detecting means 28 detects the distance a between the upper surface of the die 16 and the bottom surface of the workpieces W in order to generate a corresponding (electric or electronic) distance signal. This distance signal is fed to the positioning means (not shown) of the robot.

The positioning means is a common multi-axes positioning control of the robot which allows for precise positioning of the joining tool 2 along the common axis of the operating punch 14 and the die 16. Since such position controls are well-known no further description thereof should be necessary.

The positioning means of the robot now moves the joining tool 2, in response to the distance signal, from the pre-position (shown in FIGS. 1 and 2) to the operating position wherein the bottom side of the workpieces W engages the top surface of the die 16 (FIG. 3). This movement of the joining tool 2 can be controlled by an open loop control or by a closed loop control. In any case it will ensure that the die 16 will engage the workpieces W gently and without shock so that any risk of the workpieces W being damaged or deformed is avoided.

The joining tool 2 may now perform, in a usual manner, a joining operation to join the workpieces W.

In the embodiment shown in FIGS. 1 to 3, the distance detecting means 28 is an opto-electronic position measuring device. Preferably, it is a laser position measuring device of the triangulation method type which directs a laser beam 30 upon the workpieces W, receives a reflected beam, measures the duration between emission and receipt of the laser beam, and derives therefrom a distance signal representative of distance a.

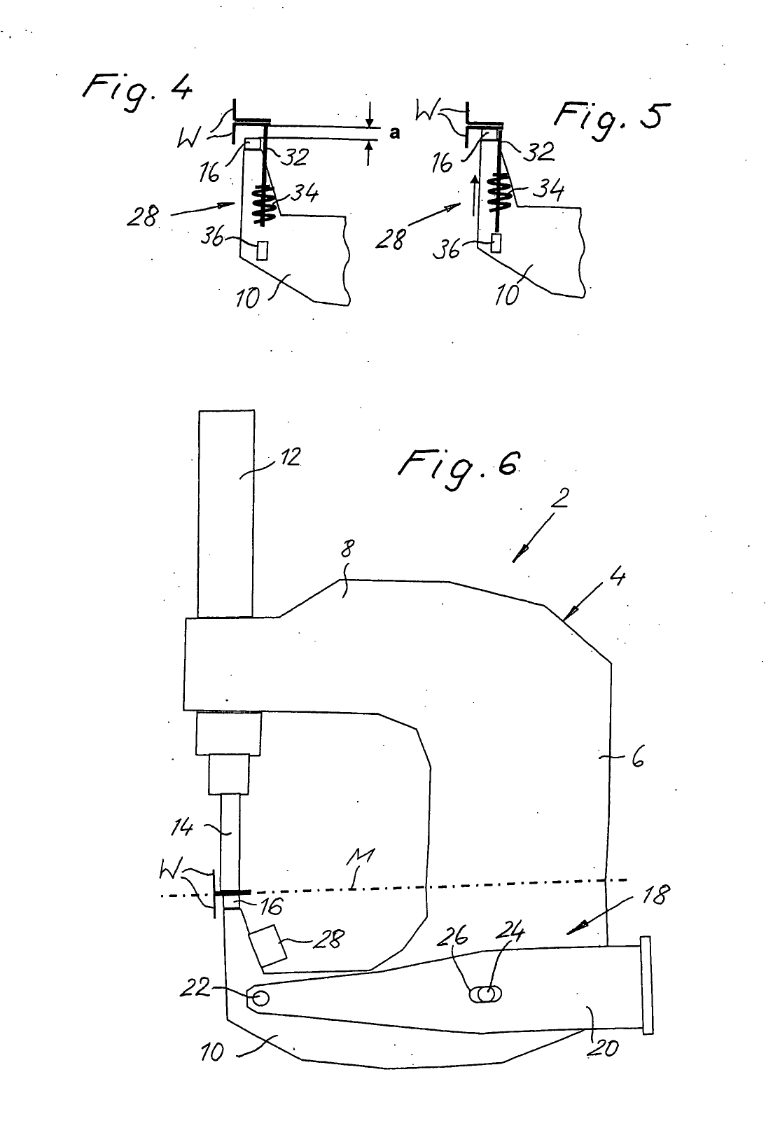

In the embodiment shown in FIGS. 4 and 5, the distance detecting means 28 is a mechanical measuring device or probe device. It includes a probe element 32 comprising a probe pin which is biased into a sensing position by a spring 34. Associated to the probe element 32 is a position measuring device 36 which senses the position of the probe element 32.

When the joining tool 2 has reached its pre-position, the probe element 32 touches the workpieces W (FIG. 4). With the assistance of the position measuring device 36 there is generated a distance signal which is fed to the positioning means (not shown) of the robot. In response to the distance signal the positioning means of the robot moves the joining tool to the operating position wherein the die 16 is in engagement with the workpieces W (FIG. 5).

It should be noted that the distance detecting means may be of other design provided it enables sufficiently precise detection of the distance a and may be integrated into the joining tool 2 in suitable manner.

As indicated schematically in FIG. 6, the joining forces which are exerted during the joining operation by the operating punch 14 via the workpieces W upon the die 16 may cause the C-shaped frame 4 to be deflected such that the upper leg 8 and the lower leg 10 of the C-shaped frame 4 are urged apart. This would result in change of the position of the die 16 and the die plane M (indicated by a dash-dotted line) where the workpieces W are disposed, unless special measures are provided to prevent such change of the positions of the die 16 and the workpieces W.

As explained above, the fixing means 18 are mounted to the lower leg 10 of the C-shaped frame 4 such that the C-shaped frame 4 is fixed to the robot as closely adjacent to the die 16 as possible.

In the embodiment shown in FIG. 6 the fixing means 18 comprise a fixing arm 20 adapted to have its (in FIG. 6) right-hand end fixed to the robot (not shown) and its left-hand end fixed to the lower leg 10 below the die 16. More precisely, the fixing arm 20 has its left-hand end fixed to the lower leg 10 by a pin 22, white the fixing arm 20 is mounted in an intermediate area to the lower leg 10 by means of a pin 24 and an elongated hole 26 of the fixing arm 20 in order to compensate for tolerances in the spacing between the two pins 22 and 24.

Fixing the joining tool 2 to the robot in closely adjacent relationship to the die 16 ensures that the position of the die 16 and, therefore, the position of the die plane M and the workpieces W remain substantially unchanged during the joining operation and will not or not substantially be affected by deflection of the C-shaped frame 4.

It should be understood that the fixing of the joining tool 2 to the robot as shown in FIG. 6 is merely an example; there is a variety of other possibilities to fix the joining tool 2 to the robot in close relationship to the die.

We claim:

1. A method of controlling an advance movement of a joining tool fixed to a robot from an initial position to an operating position wherein said joining tool performs a joining operation on at least one stationary workpiece, said joining tool comprising an operating punch and a die, and said robot being provided with positioning means, in which method:
a) said joining tool fixed to said robot is moved, with the assistance of the positioning means of said robot, from said initial position into a pre-position wherein said die of said joining tool is spaced from said workpiece by a distance,
b) said distance between said die and said workpieces is detected by a distance detecting means in order to generate a distance signal, and
c) said joining tool is moved from said pre-position to said operating position by said positioning means of said robot in response to said distance signal.

2. The method of claim 1 wherein said distance is detected by mechanical means or opto-electronic means.

3. The method of claim 1 wherein said advance movement of said joining tool from said pre-position to said operating position is controlled by open loop control means.

4. The method of claim 1 wherein said advance movement of said joining tool from said pre-position to said operating position is controlled by closed loop control means.

5. An apparatus for controlling an advance movement of a joining tool fixed to a robot from an initial position via a pre-position to an operating position wherein said joining tool performs a joining operation on at least one stationary workpiece, said workpiece being spaced from a die of said joining tool for a certain distance when said joining tool is in said pre-position,
which joining tool comprises a C-shaped frame including an intermediate portion, an upper leg and a lower leg, said upper leg carrying an actuating mechanism including an operating punch and said lower leg carrying said die,
said apparatus including a distance detecting means arranged on said C-shaped frame such as to generate, when it is in said pre-position, a distance signal in response to said distance between said die and said workpiece, said C-shaped frame being adapted to be connected to a positioning means of said robot such that said positioning means can move said joining tool to said work position.

6. The apparatus of claim 5 wherein said distance detecting means is disposed on said lower leg of said C-shaped frame closely adjacent to said die.

7. The apparatus of claim 5 wherein said distance detecting means comprises an opto-electronic distance measuring device.

8. The apparatus of claim 7 wherein said opto-electronic measuring device is a laser measuring device of the triangulation method type.

9. The apparatus of claim 5 wherein said distance detecting means comprises a mechanical probe mechanism.

10. The apparatus of claim 9 wherein said mechanical probe mechanism comprises a resiliently biased probe element for contacting said workpiece and a position sensor for sensing the position of said probe element.

11. The apparatus of claim 5 wherein said lower leg of said C-shaped frame includes fixing means for fixing said joining tool to said robot, which fixing means are disposed on said lower leg of said C-shaped frame such as to enable connecting said joining tool to said robot closely adjacent to said die.

12. The apparatus of claim 11 wherein said fixing means comprises a fixing arm extending longitudinally along said lower leg of said C-shaped frame and having an end remote from said robot and fixed to said lower leg of said C-shaped at a location below said die.
